(19) United States
(12) Patent Application Publication
(10) Pub. No.: US 2010/0049631 A1
(43) Pub. Date: Feb. 25, 2010

(54) System and method for providing online donations

(75) Inventor: Elliot S. Goldman, Fort Worth, TX (US)

Correspondence Address: RG & ASSOCIATES, 1103 TWIN CREEKS, STE. 120, ALLEN, TX, 75013, US

(73) Assignee: GL2Partners, Fort Worth, TX (US)

(21) Appl. No.: 12/229,126

(22) Filed: Aug. 20, 2008

(51) Int. Cl. G06Q 50/00

(52) U.S. Cl. 705/27; 715/738; 705/39

(57) ABSTRACT

An online donation system and method generates an online catalogue displaying available charities and specific programs run or administered by the charities. A user selects one or more programs at one or more charities by selecting a display icon of the charities. The user then initiates a donation to the charity using an e-commerce engine. The display icons include objective or emotive images to enhance the online purchase experience of the user.

### FIELD OF THE DISCLOSURE

This disclosure relates to a system and method for providing donations to multiple charities to fund at least one of: specific programs, projects and activities within those charities. The disclosure particularly relates to a system and method for providing online donations.

### BACKGROUND OF THE DISCLOSURE

One of the factors that a charity relies on for receiving donations is the feeling of good will created in the donor for providing a donation. A charity that collects donations by face to face contact or through telephone conversations is able to generate the feeling of good will and warmth through direct human interaction. However, human donation collections have a disadvantage in that they have a direct monetary cost of paying the collectors, or they have a cost in volunteer staff and other resources that could be better utilized by providing the charity services of the charity. An online donation system can therefore have great benefits in minimizing costs incurred in collecting donations. However, in an online donation system, the potential to generate the feeling of good will is reduced, with the result that a donor may be less likely to provide a donation or may reduce the size of the donation that the donor may otherwise make.

What is required is an improved system and method for providing online donations to charities.

### SUMMARY OF THE DISCLOSURE

In one aspect of the disclosure, there is provided an online donation system comprising at least one server, at least one database operatively associated with the at least one server that stores a plurality of charity records for a plurality of charities, and an electronic commerce engine. At least one charity record comprises a plurality of charity programs. The server provides an interface to a user that allows a user to select a charity program of a charity and to make a donation to a selected charity program using the electronic commerce engine.

In one aspect of the disclosure, there is provided a method for providing donations to a charity comprising generating an online page comprising a plurality of display icons, the plurality of display icons indicating a plurality of charity programs of a plurality of charities. The method also comprises providing the online page to a user, allowing a user to select at least one of the plurality of display icons, allowing the user to indicate a donation, and providing an indicated donation to a charity indicated by a selected display icon.

In one aspect of the disclosure, there is provided an online donation system comprising at least one server, and at least one database operatively associated with the at least one server that stores a plurality of charity records for a plurality of charities. At least one charity record comprises charity information and at least one display icon comprising at least one of an emotive display icon and an objective display icon. The server creates an online page for a user that displays a plurality of the display icons for respective charities. The display icons displayed on the online page provide hyperlinks to the respective charity information.

### BRIEF DESCRIPTION OF THE DRAWINGS

Reference will now be made to specific embodiments, presented by way of example only, and to the accompanying drawings in which:

FIG. 1 schematically illustrates an online donation system;

FIG. 2 illustrates an example of a donation certificate;

FIG. 3 illustrates a webpage of a donation system;

FIG. 4 illustrates an online charity catalogue;

FIG. 5 illustrates a method for providing an online donations;

FIG. 6 illustrates an online donation shopping page showing display icons;

FIG. 7 illustrates a donation shopping process; and

FIG. 8 illustrates online donation shopping using an online form.

### DETAILED DESCRIPTION OF THE DISCLOSURE

The present disclosure provides a system and method for providing at least one donation to at least one of at least three charities. The present disclosure further provides an option to fund at least one of at least two choices including: specific programs, projects and activities, within the at least one charity. The present disclosure further provides an option to make a general contribution to a specific charity. A charity is a not for profit organization with a unique tax identification number. A program is a function of a charity (such as counseling, disaster relief, direct food aid, capital campaign, infrastructure acquisition, funding of an endowment, etc.). A project defines a special event within a program (such as a youth camp for special needs children, a rehabilitation program, etc.). An activity is a function of a project that is individually discernable (such as counseling a special needs child in a youth camp, etc.). The donation system presents an online interface through which a donor may select from any number of available charities and make a charitable donation payment to the selected charity or charities. The online system costing structure is therefore more economical because a single interface can combine multiple charities together. Thus, the cost of advertising may be reduced by attracting people providing donations to multiple charities to one site.

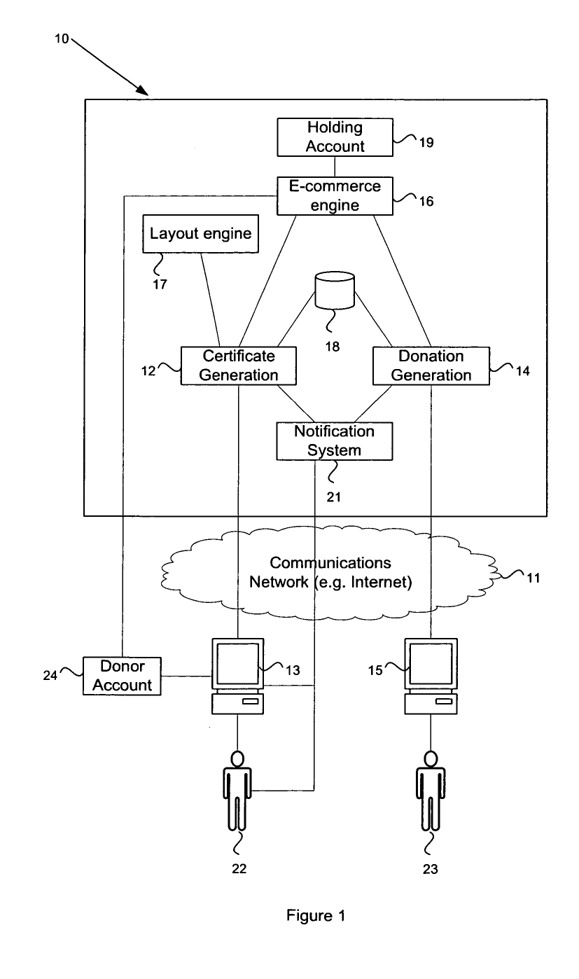

In FIG. 1, there is shown an online donation system 10. The system 10 includes a certificate generation system 12, a donation generation system 14, an electronic commerce (e-commerce) engine 16 and at least one database 18. The certificate generation system 12 is described in detail in the Applicant's copending patent application Ser. No. 12/156,677 filed on Jun. 4, 2008, the entire contents of which are incorporated herein by reference. The certificate generation system 12 allows donations to be generated by a user 22 at user interface 13. The donation certificate may be redeemed later by the user or may be given as a gift to a third party, such as user 23. The design of the certificate may be controlled by a layout engine 17 that may use standard templates, forms etc as well as user input to control the design and layout of a certificate. Details of generated donation certificates such as donation amount, a restriction of charities, nominated redeemer, donor, etc may be stored in the database 18.

The database 18 may also store charity information such as size of the organization, number of years of existence, affiliations (e.g. affiliated with national organization), type of organization (military, arts, education, social services, etc.), executive director analysis, media poll analysis (how often are they mentioned in the media—both positively and negatively), available private and public ratings of effectiveness analysis, 990 (tax form) analysis, and expense ratios. Such features may be searchable by a query engine through an interface as will be described in greater detail below. Multiple charity records may be stored in the database. In one embodiment, at least three individually searchable and selectable charity offerings are stored. In one embodiment, the individual charity offerings may be individual charities each with a unique and separate tax identification number. In one embodiment, the individual charity offerings may be from a single charity that redistributes funds to multiple charities, e.g. at least three charities that have at least two programs, projects or activities beneath it, each charity having a separate tax identification number. In one embodiment, both charities and programs of charities may be individually selectable. In one embodiment, a single not for profit charity that is funding three different not for profit charities each with individual or different tax identification numbers and within those three different not for profit charities, those funds are to be directed toward at least one of two specific programs, projects or activities within the charity. In one embodiment, at least one for profit entity that is advertising for and/or collecting funds for three different not for profit charities each with individual tax identification numbers and within those three different not for profit charities, those funds are to be directed toward at least one of two specific programs, projects or activities within the charity. In one embodiment, at least three not for profit charities with three different tax identifications fund at least one of two specific programs, projects or activities within the at least three not for profit charities.

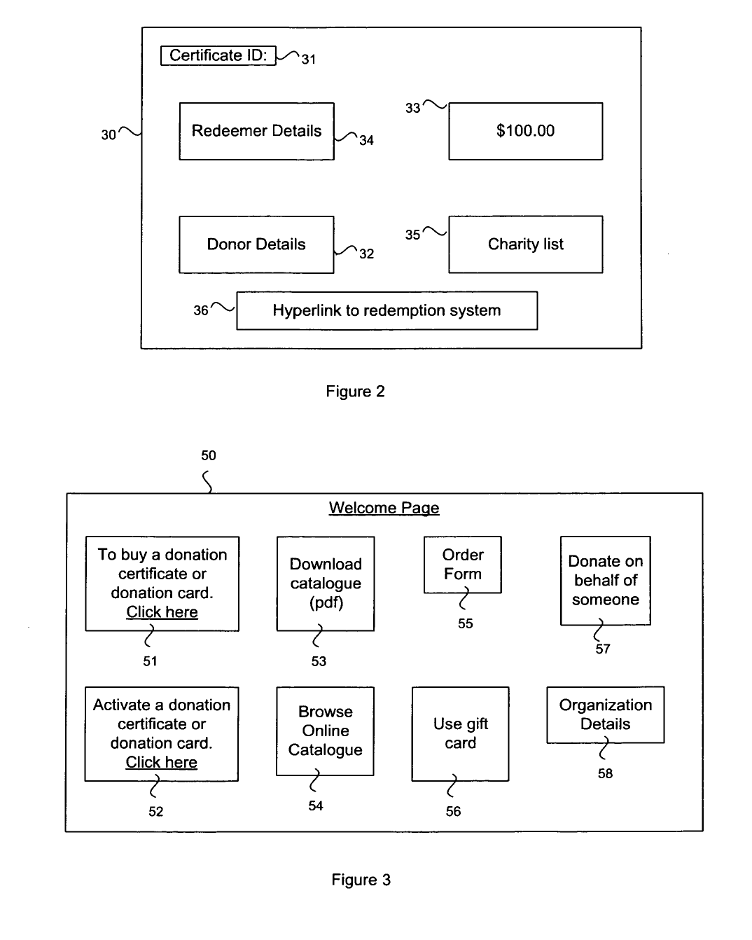

An example donation certificate 30 is depicted in FIG. 2. The donation certificate 30 includes a certificate ID 31, donor details 32, donation amount 33, and redeemer details 34. The donation certificate 30 also includes a list of charities 35 to which the donation amount may be donated when the donation certificate is redeemed. The list of charities may indicate a particular endorsed charity even though the donation certificate is not restricted to the endorsed charity. In one embodiment, the donation certificate 30 may be in the form of a certificate, and may be of any suitable size, such as A4, postcard size, etc. In one embodiment, the donation certificate may be a rechargeable card, of a similar size to a business card or store card. The donation certificate 30 may also include a link or a hyperlink 36 to a donation certificate redemption system.

The donation generation system 14 allows a user 23 to select one or more charities and make donations to those charities through a user interface 15. The donation generation system 14 may include a certificate redemption system such as the certificate redemption system described in the Applicant's copending patent application referenced above.

The certificate generation system 12 and donation generation system 14 may be provided as servers, which may include appropriate processors and memories. While the certificate generation system 12 and the donation generation system 14 are shown individually, a person skilled in the art will understand that the functions of the certificate generation system 12 and the donation generation system 14 may be combined, for example by providing a single server. Access to the certificate generation system 12 and the donation generation system 14 may be provided as a website through a suitable telecommunications network 11, such as the internet.

The interface 15 may be a graphical user interface provided on a suitable computer device. The interface 15 may communicate with the donation generation system 14 through a suitable communications system 11 such as the internet or file transfer protocol (FTP). The donation generation system 14 may operate as a web site, providing a mechanism through the interface 15 for a user to search the database 18, select charities and make donations to the selected charities.

In FIG. 3, there is shown a schematic layout of a webpage 50 providing a welcome page to an online donation system in accordance with an embodiment of the present disclosure. The welcome page 50 provides instructions for creating, purchasing and/or activating a donation certificate. For example, a user of the system may be provided with options to buy a donation certificate or card 51, activate an existing donation card 52, download a catalogue 53, e.g. in PDF format, shop by browsing an online catalogue 54, shop using an order form 55, shop using a gift card 56 or make a donation on behalf of a third party 57.

In addition to these elements, the webpage 50 may also include sponsor links, sponsor ads, other ads, messages from charities, etc. The welcome page 50 may be presented to a user before or after the user has logged into the system. If the webpage 50 is presented to the user after user login, the webpage 50 may also display known user details such as amount remaining on a donation card, previous donations that were made, as well as a portion that shows what donations “friends” have made, etc.

By selecting element 58, the user may view details of an organization including the name, address, contact information, projects, etc. as well as the 990's and 501(c)3 information.

If the user selects option 51 or 52, the user is taken to an activation process for purchasing and/or activating a donation certificate or card such as is described in the Applicant's copending patent application referenced above.

Selecting any of elements 54, 56 and 57 will take the user to an online catalogue as will be described in greater detail below. When the user selects element 53, the user is provided with an electronic document version of the online catalogue, such as in a Portable Document Format (pdf).

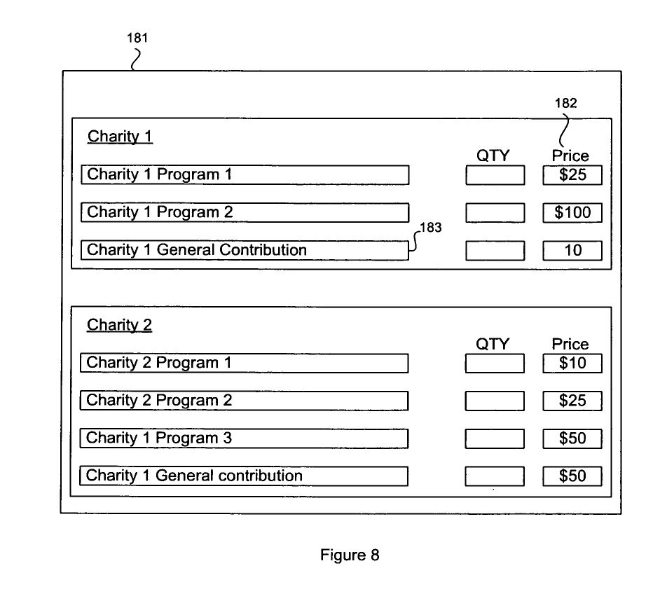

Selecting the online form 55 takes a user direct to a form, such as shown in FIG. 8 that allows users to make donation amounts 182 within a list of charity programs 181 and/or to make a general contribution 183 to the charities listed. In an alternative embodiment, the charities and/or charity programs may be selected from a drop down list.

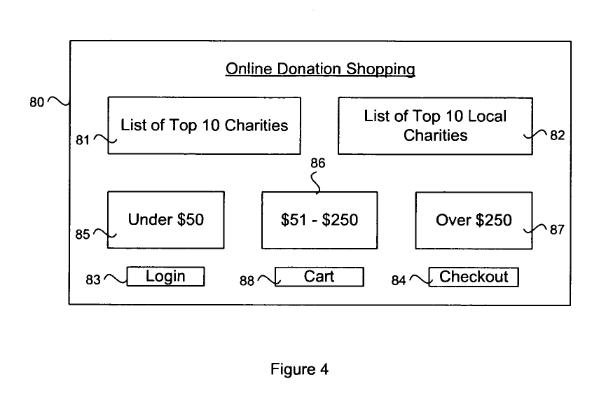

FIG. 4 schematically shows how an online store may be presented to a user. The online store allows a user to select a charity and to make a donation to that charity either anonymously, from themselves, or on behalf of another party such as a giftee, honoree or as a remembrance.

To aid in selection of charities by the user 23, an online catalogue of charities may be generated and provided by the donation generation system 14 using data from the database 18. The catalogue may specify available charities, including information about the charity, such as type of charity, area that the charity services, affiliations (e.g. religious, political), type of work (e.g. working with homeless, disaster aid, animal welfare), current projects etc. The information may also include taxation status of the charity indicating whether donations are tax deductible.

An initial page 80 of an online catalogue may present a list of top 10 charities 81, a list of top 10 local charities 82 and other elements such as a shopping cart 88, account logins 83, checkout 84 etc. Each charity listed may be provided as a hyperlink that when selected takes the user to a webpage providing more details of the selected charity. The hyperlinked page may be a summary page provided within the system or may be the home page of the respective charity. The online catalogue page 80 may also include icons that allow a user to select different donation amounts, such as an icon 85 for donations under $50, an icon 86 for donations between $51 and $250 and an icon 87 for donations over $250. Icons representing standard amounts, e.g. $100 may also be provided.

In other embodiments, the webpage 80 may also include sponsor links, sponsor ads, other ads, messages from charities etc. The webpage 80 may also include a portion that shows previous donations that were made by the user (after user login). A portion that shows what donations “friends” have made, etc. can be included.

In one embodiment, charity programs may be further subdivided into projects which may be divided further into activities. Query engines associated with the database 18 may allow searching and selection at the charity level, the program level, the project level and/or the activity level. Thus donation funds may be restricted right down to a particular activity within a charity.

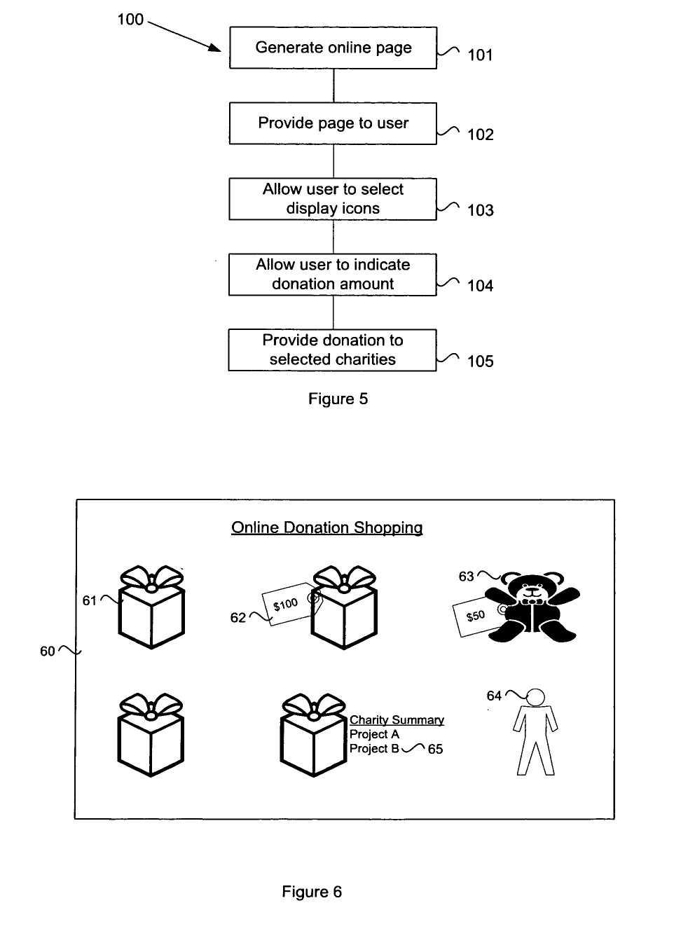

A method for providing an online donation system is depicted in the flowchart 100 of FIG. 5. The method 100 includes generating an online page (step 101) that includes display icons indicating one or more charity programs of one or more charities. The online page is presented to a user (step 102) who selects the charities and/or charity programs (step 103). After the user indicates a donation amount (step 104) the donation amount if provided to the charity or charities selected by the user (step 105).

As mentioned above, a problem with an online donation system may be that the feeling of goodwill generated in the donor can be reduced. The display icon can therefore be created to enhance the objective and/or emotive nature of the online donation purchase. By providing an objective display icon, a donor may more readily appreciate the worth of their donation and therefore be more likely to donate and/or to provide a greater donation.

FIG. 6 shows a sample webpage 60 in which several of the listed charities are depicted with gift icons 61. Each gift icon 61 is provided as a hyperlink so that the user or donor directly selects the gift icon 61 in order to make a donation purchase. The gift icon may also include a price tag 62 that further objectifies the donation purchase.

In one embodiment, the display icon may provide an emotive image that may be representative of a service provided by a charity. For example, a soup kitchen charity may provide an image of a soup cup, or similar food symbol. A charity that donates toys to under privileged children may include an image of a teddy bear or the like, such as shown by emotive display icon 63. The emotive image may also be combined with a price tag and/or combined with a gift icon, such as by depicting a teddy bear within a gift icon. The emotive image helps to convey to the donor the direct worth of their donation by indicating what the donor's donation will be used for. Using the teddy bear example, a user selecting a teddy bear icon may feel the goodwill from the imagery of purchasing a teddy bear to give to a needy child. In one embodiment, the emotive image may be a real photos (jpegs, etc.) and/or video clip of the charity and/or the specific program, the spokesperson, etc. In one embodiment, a countdown meter can be depicted on the webpage 60 (at any time during the user's interaction with the web page) to indicate at least one of: the items that were purchased, the items that need to be purchased, the dollar (or other currency) amount that was donated and the dollar (or other currency) amount that was needed. The countdown meter is useful in various instances such as when an organization needed a certain amount of spots to fund and once they were all funded, a new wish or funding request could go on the site with the countdown meter tracking the progress of the new wish. Further, use of the countdown meter motivates people to donate to a particular program because the program would be able to depict that they only needed a certain number of purchases or denomination amount to meet their goal.

In one embodiment, the emotive image may include a photo 64 that represents the people that will benefit from the user's donation.

In one embodiment, substantive information 65 about each charity is placed in close proximity to the charity icon. The information may include a summary of the uses that the charity makes of donations. This creates a feeling in the donor that their donation money is being used to directly purchase particular items or services that have a direct benefit to the recipients of the charity.

In one embodiment, the display icon may include a reference to a specific charity program. In this embodiment, a charity may have multiple listings with separate icons. Each icon may represent a separate program that is funded by the charity. For example, a charity may be involved in local community programs as well as foreign programs, and separate icons may be listed so that the donor can directly select which program to make a donation to. The listing of specific programs further enhances the feeling in the donor that they are making a direct and tangible purchase. For example, a donor may make a donation to a global charity organization but select a local charity program. The donor is thus able to feel that they have purchased an investment in the local community which they can feel proud of amongst their friends, family etc. In one embodiment, in the case of a broad reaching charity that is involved in many areas, the donor can choose one or more areas where their money should flow. In addition, the donor may be able to specify one or more areas where their money should not flow.

A further way of providing an emotive enhancement to charity selection and donation is to list similar charities together on the same page. Charities can be grouped according to many factors including geographical, religious, type of charity work performed etc. It is human nature to feel better about a purchase that has been based on informed and educated opinions and with comparisons to alternatives. Grouping similar charities and/or projects together allows a donor to make ready comparisons between possible selections and therefore to have a greater sense of satisfaction with their donation purchase.

The provision of display icons including object and/or emotive images allows the donor to feel a more direct and tangible link between the donation and the benefit to the community when the donor purchases a donation. In this way, the donor generates additional goodwill and may be encouraged to increase the amount of their donation, make additional donations, or make donations that they otherwise would not have made.

The use of display icons provides an on-line retail shopping experience so that the donor views donating as an equivalent or a substitution for a purchase of a good or a service. The ability to offer, sell and redeem “gift cards” as described above further enhances the retail nature of the online shopping experience.

In one embodiment, the locality of the user is determined, e.g. from an internet service provider of the user or from an identity of the user interface 15. Once the locality is determined, the online catalogue may be generated using the locality information so that local charities are highlighted in the catalogue. Highlighting may be performed by additional icons or symbols, by increasing the size of the display icons, using more appealing fonts, or by presenting local charity display icons on a first page of the catalogue. In one embodiment, other demographic data of the user such as known user preferences or interests may be used to generate and format the online charity catalogue.

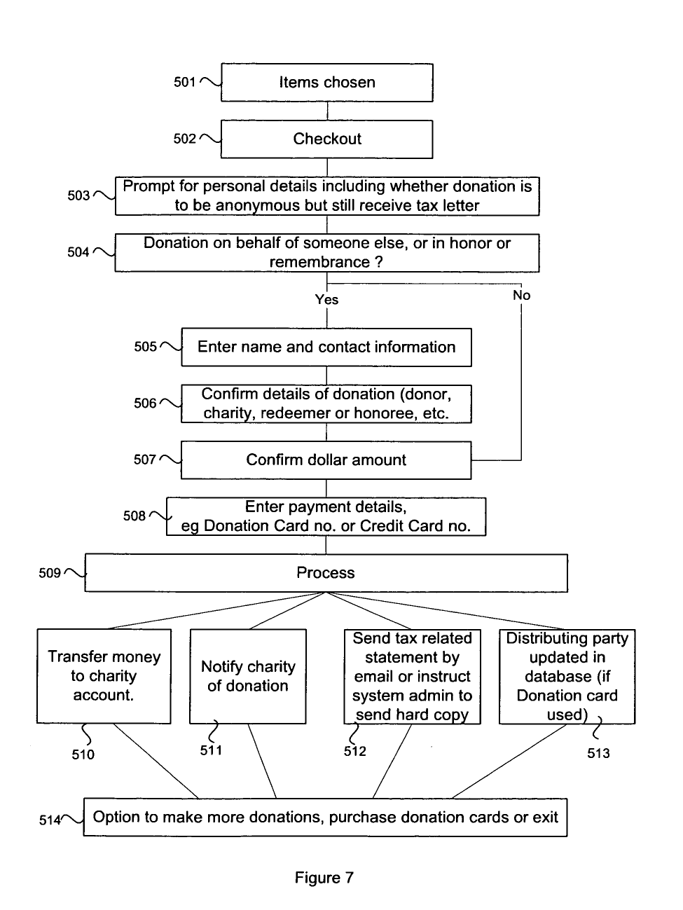

A process for online shopping presented through the web interface, including use of donation cards, will now be described with reference to FIG. 4 and to the flow chart of FIG. 7. A user chooses items 501 using the webpage 80, such as by selecting a Top 10 charity from the list 81 and by selecting the icon 85 for a donation amount under $50. Once the items are chosen, the user proceeds at step 502 to a checkout by selecting icon 84, such as the display icons illustrated in FIG. 6. The user is prompted for personal details (step 503) and whether the donation is to be made anonymously. At step 504, the user is asked whether they are making the donation themselves or on behalf of a third party. If the user selects an icon indicating a third party, the user is then prompted to enter personal details of the other party. The system may be configured to send acknowledgements on behalf of the charities to the donors. Thus, the system may confirm all the details of the donation at step 506, including providing the user with a form acknowledgement and thank you that will be sent to the other party for providing the donation. In the case where a user is donating on behalf of a third party, the user may be provided with a sample letter that will be sent to the third party. The user may be prompted to provide the information for fields of the letter, such as honoree name, address etc.

Whether the donation is being made by the user or by a third party, the process continues by prompting the user to confirm the donation amount 507 and enter payment details 508. Payment may be made by the user specifying a suitable account such as a credit card for processing by an ecommerce engine of the system. Alternatively, the user may specify a donation certificate or card number. If the user specifies a donation card number, the system accesses the donation card record in the database to determine if the donation card has sufficient current funds to meet the present donation amount.

The system then processes the donation at step 509. Processing includes transferring the donation amount to a charity account (step 510). The donation amount may be transferred from an account nominated by the user. If the user has indicated that the donation is to be made using a donation card, the transfer is made from a system account and the donation card record is updated to debit the donation amount from the donation card. Processing also includes notifying the charity of the donation 511. Where payment is provided from a user account, the user is issued with a tax statement 512. No tax statement is required when a donation card donation transaction is made if a tax statement has been provided at the time of charging money onto the donation card. If a donation card is used, the database is updated with details of the distributing entity 513. Once processing is complete, the user is provided with an option to select more donations, purchase donation cards and donation certificates or exit the system 514. The purchaser of the gift certificates can direct revenue from any unused gift certificates.

A donation certificate is created by charging a monetary amount to the certificate, for example using the e-commerce engine 16 (FIG. 1). A holding account 19 may be provided for receiving donations from a donor account 24 and retaining donations until the donation certificates are redeemed. A notification system 21 may be provided to enable statements, such as tax related information to be sent to donors.

The online catalogue system allows donors to quickly browse available charities, which may be categorized in a variety of ways such as local, most popular, etc, and to make donations using a donation card or by nominating an account. Through this process, new donations can more easily be received by the charities as the donor is more apt to give because of the online gift catalog concept and the fact that collectively and through this medium, the charities can more efficiently and cheaply get exposure and get more money. In addition, because the donations are provided online, an immediate “Thank you” to the donor may be provided together with any tax related information. The immediate thank you generates additional goodwill and enhances the donation experience for the donor.

The transfer of the donation amount is enacted by the e-commerce engine 16. If a single charity has been selected by the user, the e-commerce engine 16 and/or the donation generation system 14 looks up account details for the charity in the database 18. The e-commerce engine 16 then transfers the donation amount from the holding account 19 to the retrieved charity account. If multiple charities have been selected, account details for each charity are retrieved and the e-commerce engine transfers the donation amounts allocated to each charity by the user to the respective charity accounts.

In one embodiment, separate programs of a charity may have separate accounts so that donating to a specific charity program involves a transfer direct to that account. Alternatively, a transfer to a charity may include a reference or other indication that identifies a charity program that the money is to be used for, thus allowing a charity administrator to direct the donation funds appropriately.

Once a donation has been made, emails can be sent, e.g. via the notification system 21, to friends etc indicating the amounts donated, projects within charities that may be of interest to them, or any information regarding the charity, program, project or activity.

While a single database 18 is shown, the person skilled in the art will understand that multiple databases may be provided. The database(s) may be co-located with one or more servers of the certificate generation system 12 and/or donation generation system 14 or may be provided in a distributed manner. The databases may be accessed through the servers only, or may be accessed directly by the user 22 and/or user 23 through the communications network 11.

The donor may be an individual, group, organization or corporate entity such as a company. Similarly, the redeemer may be an individual, group, organization or corporate entity.

In the above described embodiments, donation amounts are transferred from a donor account 17 to the system holding account 19 at the time that the donation certificate is generated. In an alternative embodiment, the e-commerce engine 16 may be configured to transfer funds from the donor account 17 to a charity account (not shown) at the time of redemption, thus obviating the requirement for a holding account 19. Administration fees may still be transferred to a system account at the time of generating the donation certificate(s), or at the time of redemption.

The above described embodiments provide comprehensive examples of an online donation system. However, it will be understood by a person skilled in the art that not all of the above described specific features, functions, steps, components and elements are essential to produce an online donation system providing enhanced features and benefits compared to the prior art.

An advantage of the online donation system of the above described embodiments includes the ability for a donor to restrict funds. Most charities do not have the ability to provide a restricted funds on-line donation option, and generally prefer non-restricted funds so that they can spend the money as they please. In addition, charities are not generally set up to allow a donor to fund a specific activity within a specific project within a specific program. The online donation system may allow a donor to restrict funds at the activity, project, or program level which may provide a greater donation incentive for the donor who may then donate more money.

A further advantage of an online donation system as described is that it provides the ability for organizations to combine with other organizations, even if they have different missions, in an effort to raise capital.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. An online donation system comprising:
at least one server; and
at least one database operatively associated with the at least one server that stores a plurality of charity records for a plurality of charities; and
an electronic commerce engine;
wherein at least one charity record comprises a plurality of charity programs;
wherein the server provides an interface to a user;
wherein the interface allows a user to select a charity program of a charity and to make a donation to a selected charity program using the electronic commerce engine.

2. The online donation system according to claim 1 wherein the interface allows a user to select a charity program of a charity that is to be excluded from a donation by the user to the respective charity.

3. The online donation system according to claim 1 wherein a charity record further comprises a display icon for each charity program of a respective charity.

4. The online donation system according to claim 3 wherein the interface provides an online page comprising a plurality of display icons for a plurality of charity programs.

5. The online donation system according to claim 4 wherein each display icon on the online page provides a hyperlink to charity program information for the respective charity program.

6. The online donation system according to claim 1 wherein the at least one database stores a charity record for at least one of at least three individually selectable charities and at least one of at least two individually selectable programs, projects and activities within the at least one individually selectable charities.

7. The online donation system according to claim 6 wherein at least one of the individually selectable charity programs, projects and activities is further divided into a plurality of individually selectable subdivisions.

8. The online donation system according to claim 6 wherein each individually selectable charity comprises a unique tax identification number.

9. A method for providing donations to a charity comprising:
generating an online page comprising a plurality of display icons, the plurality of display icons indicating a plurality of charity programs of a plurality of charities;
providing the online page to a user;
allowing a user to select at least one of the plurality of display icons;
allowing the user to indicate a donation; and
providing an indicated donation to a charity indicated by a selected display icon.

10. The method according to claim 9 wherein providing an indicated donation to a charity comprises transferring an indicated donation from a holding account to a charity account of the indicated charity.

11. The method according to claim 9 comprising providing an indicated donation to a charity program indicated by the selected display icon.

12. The method according to claim 11 wherein providing an indicated donation to a charity comprises transferring an indicated donation from a holding account to a charity program account of the indicated charity program.

13. The method according to claim 11 wherein providing an indicated donation to a charity comprises transferring an indicated donation from a holding account to a charity account of the indicated charity and indicating to the charity a charity program associated with the donation to the charity.

14. An online donation system comprising:
at least one server; and
at least one database operatively associated with the at least one server that stores a plurality of charity records for a plurality of charities, wherein at least one charity record comprises:
charity information; and
at least one display icon comprising at least one of an emotive display icon and an objective display icon;
wherein the server creates an online page for a user;
wherein the online page displays a plurality of the display icons for respective charities; and
wherein the display icons displayed on the online page provide hyperlinks to the respective charity information.

15. The online donation system according to claim 14 wherein at least one charity record comprises a plurality of charity programs and a plurality of display icons associated with the plurality of charity programs.

16. The online donation system according to claim 15 wherein the online page displays a plurality of display icons for a plurality of charity programs of a charity.

17. The online donation system according to claim 16 wherein the online page allows a user to individually select at least one charity program of a charity.

18. The online donation system according to claim 17 wherein the server allows a user to make a donation to a selected charity program of a charity.

19. The online donation system according to claim 18 wherein the server allows a user to exclude a charity program from a donation to the respective charity by the user.

20. The online donation system according to claim 14 wherein at least one emotive display icon comprises a photograph of a donation beneficiary.
